(19) United States
(12) Patent Application Publication
(10) Pub. No.: US 2016/0009409 A1
(43) Pub. Date: Jan. 14, 2016

(54) STRUCTURE FOR PROVIDING AN AIRCRAFT WITH EMERGENCY ELECTRIC POWER

(71) Applicant: MICROTURBO, Toulouse (FR)

(72) Inventor: Jean-Francois Rideau, Tournefeuille (FR)

(21) Appl. No.: 14/764,150

(22) PCT Filed: Jan. 23, 2014
(86) PCT No.: PCT/FR2014/050135

§ 371 Date: Jul. 28, 2015

(30) Foreign Application Priority Data
Jan. 29, 2013 (FR) 1350727

(51) Int. Cl. B64D 41/00; F03D 7/00; F03D 9/00

(52) U.S. Cl. CPC B64D 41/007; F03D 9/002; F03D 7/00

(57) ABSTRACT

The invention concerns a structure (3) for providing emergency electric power to an aircraft (1) comprising a pressurized cabin (10), at least one main engine and an auxiliary power unit (APU), the structure being designed to provide electric power to the aircraft in the event of failure of the main engine and the emergency auxiliary unit, the structure comprising a circuit (30) for recovering air from the cabin (10), and an electricity-generating system (32, 24, 34) which generates electricity by depressurizing the air recovered from the cabin (10).

### FIELD OF THE INVENTION

The field of the invention is that of architectures for supplying emergency power in an aircraft and their use when other means for generating power in an aircraft are unusable.

### PRIOR ART

Aircraft are equipped with several means of generating power, among which are:
the main engines, which provide for propulsion of the aircraft,
an auxiliary engine called an auxiliary power unit or APU, the function whereof is to supply non-propulsive power (for example electrical power, maintaining hydraulic and pneumatic pressures, air conditioning) for the aircraft on the ground and possibly in flight, when the main engines are not able to do it or when it is desired to save fuel on the ground, and
an emergency electric power source, the function whereof is to supply emergency electric power for keeping in operation the critical flight systems for operating the aircraft in the event of loss of other power generating sources. For example, the emergency electric power source includes an electrical generator to supply flight control systems and critical flight instruments.

In order not to be subject to the same breakdowns as the main engines and the auxiliary power unit, the electric power source must be independent and operate in particular from an energy source other than the fuel of the aircraft (a fuel loss being a breakdown common to the two other engines).

The emergency power source currently installed on aircraft is called RAT, an acronym for ram air turbine. This is a propeller associated with an electrical generator, which is deployed for example ahead of the nose of the aircraft in the case of a general breakdown of the main engines and of the auxiliary engine APU. Its operation makes use of the speed of the aircraft which drives the propeller and allows the dynamic energy of flight to be recovered.

Because this is an emergency power source, its presence is necessary and, even though it is rarely used, it must be regularly checked to ensure its proper operation. This source therefore imposes high maintenance constraints.

In addition, it represents a considerable load for the aircraft. Finally, it imposes on the aircraft constraints of vibration resistance due to its operation.

### PRESENTATION OF THE INVENTION

The invention has as its goal to compensate for at least one shortcoming cited above, by proposing an architecture for supplying emergency power not having the drawbacks of the RAT architecture.

In this regard, the invention has as its object an architecture for supplying emergency electrical power to an aircraft including pressurized cabin, at least one main engine, an auxiliary power unit APU including an alternator, and a circuit for allowing air coming from the cabin to exhaust to the outside, said architecture being designed to supply electrical power to the aircraft in the event of a breakdown in the main engine and of the auxiliary power unit, and including:
a circuit for recovering air from the cabin,
an air distribution valve connecting the air recovery circuit to the exhaust circuit,
a control for said valve for modulating the flow of air in the recovery circuit,
a system for producing electricity by expansion of the air recovered from the cabin, said system including a turbine supplied with air recovered from the cabin, a rotating shaft driven by the turbine, and an alternator driven by the rotating shaft, and
a shiftable transmission gearbox designed to selectively connect the alternator to a drive shaft of the auxiliary power unit or to the rotating shaft driven by the turbine,
   the architecture being characterized in that control of the valve is also configured to control the disengagement of the transmission gearbox.

Advantageously but optionally, the architecture according to the invention further includes a variable blocking system at the entrance to the turbine, configured to modulate the power of the turbine.

The invention also has as its object an aircraft comprising a pressurized cabin, at least one main engine and an auxiliary power unit APU, characterized in that it further comprises an architecture for supplying emergency electrical power according to the foregoing presentation.

The invention also relates to a method for supplying emergency electrical power in an aircraft comprising a pressurized cabin, at least one main engine, an auxiliary power unit APU and an architecture for supplying emergency electrical power according to the foregoing presentation, the method including the steps consisting of:
during normal aircraft operation, controlling the distribution valve in a first configuration such that all the air recovered from the pressurized cabin is exhausted to the outside, and
in the event of detection of an engine breakdown of the aircraft, controlling the distribution valve to adopt a second configuration wherein at least a part of the air recovered from the cabin is directed to the recuperation circuit to feed the electric power production system.

Advantageously but optionally, the method for supplying power can further include at least one of the following features:
the implementation step in the event of detecting an engine breakdown of the aircraft also includes the simultaneous control of the disengagement of the transmission gearbox from the auxiliary power unit to connect the alternator of said unit to the rotating shaft driven by the turbine.
The method is implemented in an aircraft including an architecture for supplying emergency electrical power including a variable blocking system in the entrance to the turbine, configured to modulate the power of the turbine, and wherein the power of the turbine is modulated according to the altitude of the aircraft.
The architecture for supplying emergency power according to the invention makes it possible to use energy available on board an aircraft in flight, the pressurization of the air contained in the cabin.

This architecture is integrated with the fuselage of the aircraft; it therefore does not cause any problems with integration or vibrations. It is also lighter than a RAT architecture, and it is simple to check its operation because, unlike the RAT architecture, it does not have to be deployed outside the aircraft to be tested.

This architecture for supplying emergency power is even lighter and better integrated if is connected to the alternator of the auxiliary power unit APU.

### DESCRIPTION OF THE FIGURES

Other characteristics, goals and advantages of the invention will be revealed by the description hereafter, which is purely illustrative and not limiting, and which must be read with reference to the appended drawings, wherein:

FIG. 1 shows an architecture for supplying emergency power in an aircraft according to one embodiment of the invention,

FIG. 2 shows an architecture for supplying emergency power in an aircraft according to an alternative embodiment of the invention,

FIG. 3 shows the principal steps of the method of supplying power according to one embodiment of the invention.

### DETAILED DESCRIPTION OF AT LEAST ONE EMBODIMENT

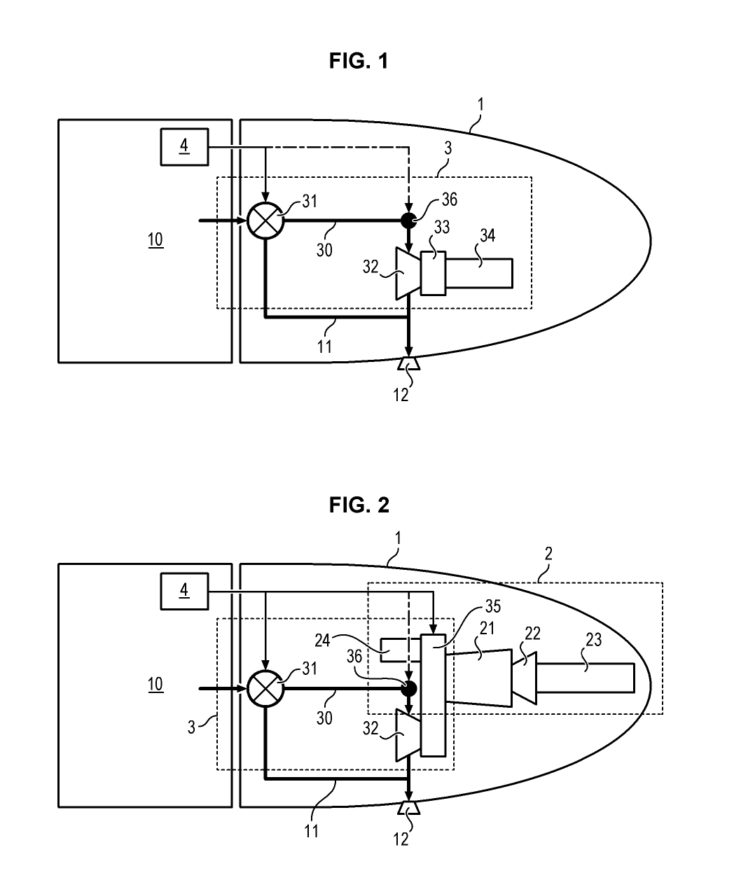

Shown schematically in FIGS. 1 and 2 is a partial view of an aircraft which includes the main engines providing its propulsion (not shown), an auxiliary power unit APU 2 (shown in FIG. 2), and an architecture for supplying emergency electrical power 3. As illustrated in the figures, the architecture for supplying emergency electrical power is installed in a compartment of the aircraft.

As indicated above, the auxiliary power unit APU 2 is configured to supply non-propulsive electrical power, that is dedicated to flight systems such as electrical power supply, hydraulic and pneumatic pressure of equipment or even air conditioning. This group can be used on the ground or in flight, and advantageously as a supplement to the main engines.

The architecture for supplying emergency electrical power is of smaller dimensions that the auxiliary power unit APU because it is configured only to supply critical flight systems, only when the main engines and the auxiliary power unit APU are not in working order. It is for this reason designed to supply between 10 and 20% of the nominal power of the main engines and is completely independent of the rest of the system (particularly not having the same energy source as the other means of supplying power).

The aircraft also comprises a pressurized cabin 10, for example a passenger cabin, as well as a circuit 11 for exhausting the air contained in the cabin to the outside of the aircraft. By pressurized cabin is meant a cabin in which the air that it contains is pressurized with respect to the outside air, particularly when the aircraft is in flight.

This circuit makes possible the continuous renewal of the air contained in the cabin. It comprises in particular a valve 12 for exhausting air to the outside wherein there circulates a predetermined air flow to allow said renewal.

The architecture for supplying emergency electrical power includes a circuit 30 for recovering pressurized air from the cabin which is connected to the circuit 11 for exhausting air to the outside by a distribution valve 31. This circuit makes it possible to draw, by modulating the opening of the distribution valve 31, a predetermined proportion of the air in the flow exhausted to the outside.

In this regard, the valve is controlled by a controller 4, which is preferably an electronic control. The distribution valve 31 is advantageously designed to assume at least two configurations to modulate the quantity of air drawn from the recovery circuit, from a first configuration wherein the entire air flow in the exhaust circuit is exhausted to the outside to a second configuration wherein the entire air flow in the exhaust circuit is drawn by the recovery circuit.

The architecture for supplying emergency electrical power further includes a system for producing electricity from the air recovered from the pressurized cabin. This system includes a turbine 32, which can be a radial turbine or an axial turbine, a reduction gearbox 33 and an alternator 34. When the turbine is supplied with air coming from the cabin, it drives in rotation a rotating shaft (not shown) which drives the alternator through the reduction gearbox.

The recovered air from the pressurized cabin is expanded in the turbine to reach the pressure of the ambient air outside the airplane, then is exhausted into the atmosphere via the exhaust valve 12.

Thus, by way of a non-limiting example, for an airplane in flight at an altitude on the order of 12,000 meters, the air in the cabin is pressurized to about 0.8 bar, while the pressure of the air outside the airplane is 0.2 bar. If the exhaust circuit 11 exhausts a quantity of 0.6 kg/s of air to renew the air in the cabin, the architecture for supplying emergency electrical power can create up to 40 kW.

According to one alternative embodiment shown in FIG. 2, the architecture for supplying emergency electrical power is connected to the auxiliary power unit APU 2. This includes, in a manner known per se, a turbine driving an air compressor, through a drive shaft, shown schematically in the figure under reference 21, and an exhaust nozzle 22 and a duct 23 for exhausting the gas.

An alternator 24 is also mounted on the drive shaft of the auxiliary power unit 2, which generates electricity for other power-consuming devices of the aircraft (not shown) such as for example the pressurization systems, cabin air conditioning, the electrical network, the hydraulic circuit, the flight systems etc., or even an oil system cooling the alternator.

In this embodiment, in the event of using the architecture to supply emergency power, the turbine 32 of the architecture drives the alternator 24 of the auxiliary power unit 2. The architecture 2 then includes a shiftable transmission gearbox 35 which is configured to selectively connect the alternator 24 to the transmission shaft of the auxiliary power unit 21 or to the rotating shaft driven by the turbine 32.

Advantageously, this transmission gearbox 35 is controlled by the same control 4 as the distribution valve 31 because then, in the event of activation of the architecture for supplying emergency power, the control 4 simultaneously causes the valve 31 to commute so that an air flow is recovered by the circuit 30, and commute the transmission gearbox 35 to connect the turbine 32 to the alternator 24 of the auxiliary power unit APU.

In addition, advantageously whatever the embodiment of the architecture, this further comprises a variable timing system 36 at the input to the turbine 32 allowing the power of the turbine to be modulated by adjusting its flow area, and due to its flow, the degree of expansion being for its part imposed by the difference in pressure between the cabin and the atmosphere outside the aircraft. This modulation makes it possible to ensure that the turbine operates at its optimum efficiency.

Thus, as the architecture is an emergency system, during its use the aircraft is necessarily in a descent phase in order to land. The energy recoverable by the architecture will therefore diminish progressively as the aircraft loses altitude. The variable blocking system makes it possible to supply more power at low altitude by increasing the flow of air expanded by the turbine.

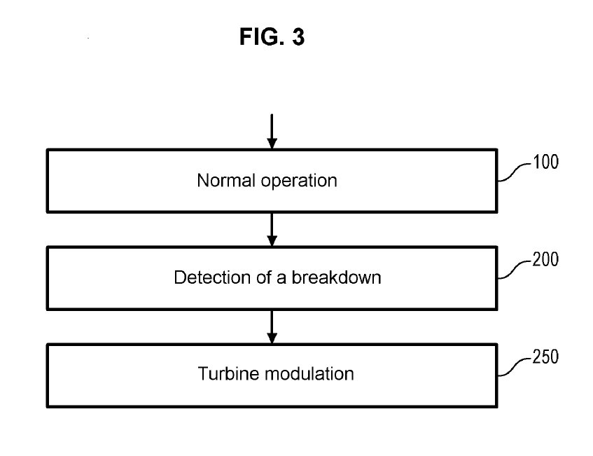

An aircraft provided with such a power supply architecture therefore operates in the following manner, with reference to FIG. 3:
In the event of normal operation 100, the main engines are operating and the auxiliary power unit can possibly generate non-propulsive power. The distribution valve 31 is in the first configuration where the recovery circuit 30 does not draw any air, and the transmission gearbox 35 is in a position wherein the turbine of the APU unit drives in rotation the alternator 24.
In the event that a malfunction such as an engine breakdown is detected 200, the control 4 toggles the configuration of the valve 31 so that the recovery circuit 30 draws a quantity of air and supplies the turbine 32. Simultaneously or after a short period of time, the control 4 causes the disengagement of the transmission gearbox 35 so that the turbine 32 drives the alternator 24 of the APU unit.
Thus, during the descent of the aircraft, 250, the power of the turbine is modulated by varying its flow by the variable timing system 36, which can be controlled in its turn by the control 4.

An architecture for emergency power is thus proposed which is integrated into an aircraft, and the operation, as well as the control whereof does not require deployment outside the aircraft. Its possible coupling with the auxiliary power group makes the assembly better integrated and lighter.

1. An architecture for supplying emergency electrical power to an aircraft including a pressurized cabin, at least one main engine, an auxiliary power unit APU including an alternator and a circuit for exhausting air from the cabin to the outside, said architecture being designed to supply electrical power to the aircraft in the event of a breakdown of the main engine and the emergency auxiliary unit, and including:
a circuit for recovering air coming from the cabin,
an air distributing valve connecting the air recovery circuit to the evacuation circuit,
a control for said valve to modulate the flow of air in the recovery circuit,
a system for producing electricity by expansion of the air recovered from the cabin, said system including a turbine supplied with air recovered from the cabin, a rotating shaft driven by the turbine and an alternator driven by the rotating shaft, and
a shiftable transmission gearbox designed to selectively connect the alternator to a drive shaft of the auxiliary power unit or to the rotating shaft driven by the turbine
the architecture being characterized in that the control of the valve is further configured to control the disengagement of the transmission gearbox.

2. The architecture according to claim 1, further including a variable timing system at the input to the turbine configured to modulate the power of the turbine.

3. An aircraft, comprising a pressurized cabin, at least one main engine, and an auxiliary power unit APU, characterized in that it further comprises an architecture for supplying emergency electrical power according to claim 1.

4. A method for supplying emergency electrical power in an aircraft comprising a pressurized cabin, at least one main engine, an auxiliary power unit APU, and an architecture for supplying emergency electrical power according to claim 1, the method including:
during normal operation of the aircraft, controlling the distribution valve in a first configuration such that all the air recovered from the pressurized cabin is exhausted to the outside, and
in the event of detection of an engine breakdown of the aircraft, control the distribution valve to assume a second configuration wherein at least a part of the air recovered from the pressurized cabin is directed into the recovery circuit to supply the electrical power production system.

5. The method according to claim 1, wherein the implementing step in the event of detection of an engine breakdown of the aircraft further includes the simultaneous control of the disengagement of the transmission gearbox from the auxiliary power unit to connect the alternator of said unit to the rotating shaft driven by the turbine.

6. The method according to claim 4, implemented in an aircraft comprising an architecture for supplying emergency electrical power according to claim 2, wherein the power of the turbine is modulated depending on the altitude of the aircraft.
